(19) United States
(12) Patent Application Publication
(10) Pub. No.: US 2019/0220496 A1
(43) Pub. Date: Jul. 18, 2019

(54) OPTIMIZATION SYSTEM, OPTIMIZATION METHOD, AND OPTIMIZATION PROGRAM

(71) Applicant: NEC CORPORATION, Tokyo (JP)

(72) Inventors: Shinji ITO, Tokyo (JP); Ryohei FUJIMAKI, Tokyo (JP)

(73) Assignee: NEC Corporation, Tokyo (JP)

(21) Appl. No.: 16/301,662

(22) PCT Filed: May 1, 2017
(86) PCT No.: PCT/JP2017/017181

§ 371 Date: Nov. 14, 2018

Related U.S. Application Data
(60) Provisional application No. 62/338,020, filed on May 18, 2016.

(51) Int. Cl. G06F 17/11; G06F 17/18; G06F 17/16

(52) U.S. Cl. CPC G06F 17/11; G06Q 10/04; G06F 17/16; G06F 17/18

(57) ABSTRACT

An accepting unit 81 accepts an optimization problem that can be formulated as BQP represented by z^{T}Az+b^{T}z by use of an n×n square matrix A and an n-dimensional vector b. A condition storage unit 82 stores characteristic conditions representing characteristics of a positive weighted directed graph. An optimization unit 83 transforms the optimization problem based on the characteristic conditions, and solves the accepted optimization problem by solving the transformed problem as a minimum cut problem of a network flow.

### TECHNICAL FIELD

The present invention relates to an optimization system, an optimization method, and an optimization program for performing binary quadratic programming (BQP) optimization.

### BACKGROUND ART

Various optimization methods have been proposed so that various resources can be appropriately used. Examples of utilizing optimization include optimization of product prices and inventory optimization.

In Non Patent Literature 1, BQP is described as an example of an optimization method. BQP can formulate objects to be optimized in a versatile manner. For example, BQP can also be used for optimizing complicated problems such as a problem involving variables having a correlation with each other.

### CITATION LIST

### Non Patent Literature

NPL 1: Kengo Katayama, Hiroyuki Narihisa, “On Local Search Heuristics for Binary Quadratic Programming Problem”, Bulletin of Okayama University of Science, Vol. 35, A, pp. 179-187, 1999

### SUMMARY OF INVENTION

### Technical Problem

BQP is known as an NP-hard problem. Therefore, when a computer attempts to perform a BQP optimization process by using the method described in Non Patent Literature 1, there is a technical problem of difficulty in efficiently performing an optimization process in the case where, for example, the amount of information to be optimized has increased.

Meanwhile, in the real world, there are cases where an exact solution does not necessarily need to be found, depending on constraints assumed according to the characteristics of optimization targets. For example, when the price of a product is reduced, there exists a relationship between the product and other products of the same kind as follows. While sales of the product reduced in price increase, sales of other products of the same kind decrease. Such a relationship is a constraint assumed according to the characteristics of optimization targets, and is effective for improving the speed of optimization.

Therefore, an object of the present invention is to provide an optimization system, an optimization method, and an optimization program for allowing a BQP optimization process to be more efficiently performed.

### Solution to Problem

An optimization system according to the present invention includes: an accepting unit that accepts an optimization problem that can be formulated as BQP represented by

[Math 1]

Maximize z^{T}Az+b^{T}z (Expression A)

by use of an n×n square matrix A and an n-dimensional vector b; a condition storage unit that stores characteristic conditions representing characteristics of a positive weighted directed graph; and an optimization unit that solves the accepted optimization problem, wherein the accepting unit accepts an optimization problem in which the BQP in Expression A satisfies constraints represented by Expression B

[Math 2]

subject to z=[z₁, . . . ,zₙ]^{T}∈{0,1}ⁿ,

zᵢ≤zⱼ((i,j)∈C), (Expression B)

in a case where C is defined as an N×N combination, and the optimization unit transforms the optimization problem based on the characteristic conditions, and solves the accepted optimization problem by solving the transformed problem as a minimum cut problem of a network flow.

In addition, an optimization method according to the present invention includes: accepting an optimization problem in which BQP in Expression A above satisfies constraints represented by Expression B above in a case where C is defined as an N×N combination, among optimization problems that can be formulated as the BQP represented by Expression A above by use of an n×n square matrix A and an n-dimensional vector b; and transforming the optimization problem based on characteristic conditions representing characteristics of a positive weighted directed graph, and solving the accepted optimization problem by solving the transformed problem as a minimum cut problem of a network flow.

Furthermore, an optimization program according to the present invention causes a computer to perform: an accepting process of accepting an optimization problem in which BQP in Expression A above satisfies constraints represented by Expression B above in a case where C is defined as an N×N combination, among optimization problems that can be formulated as the BQP represented by Expression A above by use of an n×n square matrix A and an n-dimensional vector b; and an optimization process of transforming the optimization problem based on characteristic conditions representing characteristics of a positive weighted directed graph, and solving the accepted optimization problem by solving the transformed problem as a minimum cut problem of a network flow.

### Advantageous Effects of Invention

According to the present invention, a computer can more efficiently perform a BQP optimization process than in the case where the computer performs the BQP optimization process by using the method described in Non Patent Literature 1. Furthermore, a technical effect is achieved in that it is possible to improve the performance of a computer that performs a BQP optimization process.

### BRIEF DESCRIPTION OF DRAWINGS

FIG. 1 It depicts a block diagram illustrating a configuration example of a first exemplary embodiment of an optimization system according to the present invention.

FIG. 2 It depicts a flowchart illustrating an operation example of an optimization system 100 according to the first exemplary embodiment.

FIG. 3 It depicts a flowchart illustrating an operation example of an optimization unit 30 according to the first exemplary embodiment.

FIG. 4 It depicts a flowchart illustrating an operation example of an optimization unit 30 according to a second exemplary embodiment.

FIG. 5 It depicts a flowchart illustrating an operation example of an optimization unit 30 according to a third exemplary embodiment.

FIG. 6 It depicts a flowchart illustrating an operation example of an optimization unit 30 in a variation of the third exemplary embodiment.

FIG. 7 It depicts a flowchart illustrating an operation example of the optimization unit 30 in the variation of the third exemplary embodiment.

FIG. 8 It depicts a block diagram illustrating an outline of the optimization system according to the present invention.

### DESCRIPTION OF EMBODIMENTS

Hereinafter, exemplary embodiments of the present invention will be described with reference to the drawings.

### First Exemplary Embodiment

An optimization system according to the present exemplary embodiment optimizes a problem that can be formulated as BQP. The optimization system according to the present exemplary embodiment accepts a problem that can be formulated as BQP represented by Expression 1 below.

[Math 3]

Maximize z^{T}Az+b^{T}z

subject to z=[z₁, . . . ,zₙ]^{T}∈{0,1}ⁿ,

zᵢ≤zⱼ((i,j)∈C), (Expression 1)

In Expression 1, A is an n×n square matrix, and b is an n-dimensional vector. Furthermore, C is defined by C⊆N×N (where N={1, 2, . . . , n}). Hereinafter, an element of A is denoted by aᵢⱼ, and an element of b is denoted by bᵢ. In addition, z represents each constraint.

An optimization problem for optimizing the prices of a plurality of products so as to maximize total sales is assumed in the following description. That is, in the present exemplary embodiment, the optimization system optimizes the prices of a plurality of products so as to maximize total sales based on a prediction of sales of the plurality of products. In this case, the constraint z corresponds to, for example, a business constraint (a candidate price for each product, a combination of products that can be reduced in price, and others) of a pricing strategy, which can be selected.

For example, consider a case where the sum of sales of a sandwich group for a month is to be maximized in a retail store. The sandwich group includes four kinds of sandwiches, that is, sandwiches A, B, C, and D. In this case, a problem of optimizing the respective sales prices of the sandwiches A, B, C, and D is to be solved so as to maximize the sum of sales of the sandwich group, that is, the sum of sales of the four sandwiches A, B, C, and D.

Here, an example of a prediction model for predicting the sales quantity of the sandwich A will be described. The sales quantity of the sandwich A is considered to be affected by the sales price of the sandwich A itself. In addition, it is considered that the sales quantity of the sandwich A is also affected by the sales prices of sandwiches displayed on a store shelf together with the sandwich A, that is, the sales prices of the sandwiches B, C, and D. This is because it is considered that customers who come to the retail store selectively purchase sandwiches that they prefer among the sandwiches A, B, C, and D displayed on the store shelf at the same time.

Under the circumstances, assume a day when, for example, the sandwich B is sold at a greatly reduced price. Even customers who usually purchase the sandwich A by preference may possibly select and purchase the sandwich B instead of the sandwich A on such a day. This is because the amounts of sandwiches that customers (people) can eat at a time are limited. Thus, ordinary customers are less likely to intend to purchase both sandwiches A and B.

In this case, as a result, the sales quantity of the sandwich A is reduced by the sandwich B sold at a low price. Such a relationship is called a cannibalization relationship (market cannibalization relationship).

That is, the cannibalization refers to the following relationship. A reduction in the price of a product increases the sales quantity of the product while decreasing the sales quantity of other competing products (a plurality of products similar to one another in properties and characteristics).

Therefore, the prediction model for predicting the sales quantity S_{A} (explained variable) of the sandwich A can be expressed as a function including, for example, a price P_{A} of the sandwich A, a price P_{B} of the sandwich B, a price P_{C} of the sandwich C, and a price P_{D} of the sandwich D as explanatory variables.

That is, the above-described prediction model is learned based on the explained variable (the sales quantity of the sandwich in the present exemplary embodiment) and the explanatory variables (the sales price of the sandwich, the sales prices of the competing sandwiches, and the like in the present exemplary embodiment). Furthermore, the above-described prediction model shows a relationship between the explained variable and the explanatory variables, and is expressed as a function of the explanatory variables.

The optimization system according to the present exemplary embodiment optimizes objective items, that is, the respective sales prices (that is, P_{A}, P_{B}, P_{C}, and P_{D}) of the sandwiches A, B, C, and D. Specifically, the optimization system optimizes values of objective variables (that is, P_{A}, P_{B}, P_{C}, and P_{D}) so as to maximize a value of an objective function (that is, the sum of the sales of the sandwich group) while satisfying various constraint conditions set with respect to the objective variables (that is, P_{A}, P_{B}, P_{C}, and P_{D}), and the like.

Here, a set of indices of optimization targets is represented by {m|m=1, . . . , M}. In the present specific example, the optimization targets are the prices of the respective products, and M corresponds to the number of the products. In addition, a matter to be predicted for each optimization target m is denoted by Sₘ. In the above-described example, Sₘ corresponds to the sales quantity of a product m. Furthermore, a matter to be optimized for each optimization target m (that is, an objective variable for optimization) is denoted by Pₘ or P′ₘ. In the above-described example, Pₘ corresponds to the price of the product m. When a dependence relationship between Sₘ (for example, sales quantity (demand)) and Pₘ (for example, price) is modeled by use of linear regression, the prediction model for predicting Sₘ can be represented by, for example, Expression 2 cited below as an example.

$$\begin{matrix}[ Math 4 ] & \\ {S}_{m} = {α}_{m} + {\sum }_{{m}^{′} = 1}^{M} {\sum }_{d = 1}^{D} {β}_{{mm}^{′}}^{d} {f}_{d} ( {P}_{m}^{′} ) + {\sum }_{d = 1}^{{D}^{′}} {γ}_{d}^{m} {g}_{d} & ( Expression 2 )\end{matrix}$$

In Expression 2, f_{d} is a feature generation function, and represents a transform with respect to P′ₘ. In addition, D represents the number of feature generation functions, and represents the number of transforms performed with respect to P′ₘ. Details of f_{d} can be determined at the discretion of a user. For example, f_{d} may be a function that performs a linear transform, or a function that performs a non-linear transform, such as a logarithm and a polynomial. As described above, when Pₘ is the price of the product m, and Sₘ represents the sales quantity of the product m, f_{d} represents, for example, a response of sales to the price. Examples of a response of sales include the following. In the case where the price of a product is reduced to a certain degree, a response of sales improves, or gets worse. Alternatively, in response to a price reduction, the sales quantity is squared.

Furthermore, in Expression 2, g_{d} is an external feature (in the above-described example, weather and the like), and D′ is the number of external features. It should be noted that with respect to the external features, a transform may be performed in advance. Moreover, in Expression 2, α is a constant term, and β and γ are coefficients of a regression expression obtained as a result of machine learning. As is clear from the above description, the prediction model is learned based on the explained variable (Sₘ) and the explanatory variables (Pₘ, various external features, and the like). Furthermore, the prediction model shows a relationship between the explained variable and the explanatory variables, and is expressed as a function of the explanatory variables.

In addition, since sales of products are represented by the sum of products of the prices of the products and the sales quantity of the products, the optimization system optimizes, for example, an objective function represented by Expression 3 below.

$$\begin{matrix}[ Math 5 ] & \\ {max}_{Z} {\sum }_{m = 1}^{M} {P}_{m} {S}_{m} & ( Expression 3 )\end{matrix}$$

It should be noted that in the course of performing such optimization, the prediction model based on machine learning, as described above, may be based on a non-linear basis function in some cases. For example, with respect to the above-described price prediction problem, it is assumed that a non-linear transform, such as the square of a price and the logarithmic conversion of a price, is performed as a feature amount to be input to the prediction model based on machine learning. In this case, an objective function of mathematical optimization (sales for a specific period of time in the future) is a function of a feature amount obtained by a non-linear transform of a price in a complicated manner. Therefore, it is difficult to efficiently attain a solution for such mathematical optimization by using a general method.

Meanwhile, the prices of products have consecutive values. However, in fact, the number of candidate prices is often limited to a finite number. Then, let {k|k=1, . . . , K} be a set of indices of matters to be optimized. In the above-described example, K corresponds to the number of candidate prices. For example, suppose there are four candidate prices “no discount, a 1% discount, a 2% discount, and a 5% discount” for the product “sandwich A.” Then, K=4. Furthermore, a set of candidates of matters to be optimized for the product m is denoted by Pₘₖ with an overbar, as shown below. In the above-described example, Pₘₖ with an overbar represents a candidate price for the product m.

{P̅ₘₖ} [Math 6]

In addition, the k-th indicator of m is denoted by Zₘₖ. Here, Zₘₖ satisfies the following condition.

Zₘₖ∈{1,0} where Σₖ₌₁^{k}Zₘₖ=1 [Math 7]

In the case of defining as described above, the price Pₘ of the product m is defined by Expression 4 cited below as an example.

$$\begin{matrix}[ Math 8 ] & \\ {P}_{m} = {\sum }_{k = 1}^{K} {Z}_{mk} {\overline{P}}_{mk} & ( Expression 4 )\end{matrix}$$

In this case, Expression 2 above can be transformed as follows.

$$\begin{matrix}[ Math 9 ] & \\ \begin{matrix}{S}_{m} = {α}_{m} + {\sum }_{{m}^{′} = 1}^{M} {\sum }_{d = 1}^{D} {β}_{{mm}^{′}}^{d} {f}_{d} ( {\sum }_{k = 1}^{K} {Z}_{{m}^{′} k} {\overline{P}}_{{m}^{′} k} ) + {\sum }_{d = 1}^{{D}^{′}} {γ}_{d} {g}_{d} \\ = {α}_{m} + {\sum }_{{m}^{′} = 1}^{M} {\sum }_{d = 1}^{D} {β}_{{mm}^{′}}^{d} {\sum }_{k = 1}^{K} {Z}_{{m}^{′} k} {f}_{d} ( {\overline{P}}_{{m}^{′} k} ) + {\sum }_{d = 1}^{{D}^{′}} {γ}_{d} {g}_{d} \\ = {α}_{m} + {\sum }_{{m}^{′} = 1}^{M} {\sum }_{k = 1}^{K} {Z}_{{m}^{′} k} {\sum }_{d = 1}^{D} {β}_{{mm}^{′}}^{d} {f}_{d} ( {\overline{P}}_{{m}^{′} k} ) + {\sum }_{d = 1}^{{D}^{′}} {γ}_{d} {g}_{d} \\ = {α}_{m} + {\sum }_{{m}^{′} = 1}^{M} {\sum }_{k = 1}^{K} {Z}_{{m}^{′} k} {F}_{{mm}^{′}}^{k} + {\sum }_{d = 1}^{{D}^{′}} {γ}_{d} {g}_{d}\end{matrix} & \\ where {F}_{{mm}^{′ }}^{k} = {\sum }_{d = 1}^{D} {β}_{{mm}^{′}}^{d} {f}_{d} ( {\overline{P}}_{{m}^{′} k} ) & \end{matrix}$$

Moreover, Expression 3 above can be transformed into Expression 5 cited below as an example. It should be noted that in Expression 5, Z is defined by Z=(Z₁₁, . . . , Z_{1K}, . . . , Z_{MK}).

$$\begin{matrix}[ Math 10 ] & \\ {max}_{Z} {\sum }_{m = 1}^{M} {P}_{m} {S}_{m} \\ s . t . {\sum }_{k = 1}^{K} {Z}_{mk} = 1 , \\ {Z}_{mk} ∈ \{ 1 , 0 \} & ( Expression 5 )\end{matrix}$$

Furthermore, Expression 5 above can be further transformed into Expression 6 below.

$$\begin{matrix} [ Math 11 ] & \\ {\sum }_{m = 1}^{M} {P}_{m} {S}_{m} = {\sum }_{m = 1}^{M} ( {\sum }_{k = 1}^{K} {Z}_{mk} {\overline{P}}_{mk} ) ( {α}_{m} + {\sum }_{{m}^{′} = 1}^{M} {\sum }_{k = 1}^{K} {Z}_{{m}^{′} k} {F}_{m {m}^{′}}^{k} + {\sum }_{d = 1}^{{D}^{′}} {γ}_{d} {g}_{d} ) = {{\sum }_{m = 1}}^{M} ( ( {\sum }_{k = 1}^{K} {Z}_{mk} {\overline{P}}_{mk} ) ( {\sum }_{{m}^{′} = 1}^{M} {\sum }_{k = 1}^{K} {Z}_{{m}^{′} {k}^{′ }} {F}_{m {m}^{′}}^{{k}^{′}} ) + ( {α}_{m} + {\sum }_{d = 1}^{{D}^{′}} {γ}_{d} {g}_{d} ) ) = {\sum }_{m = 1}^{M} {\sum }_{{m}^{′} = 1}^{M} {\sum }_{k = 1}^{K} {\sum }_{{k}^{′} = 1}^{K} {\overline{P}}_{mk} {F}_{m {m}^{′ }}^{{k}^{′}} {Z}_{mk} {Z}_{{mk}^{′}} + {\sum }_{m = 1}^{M} {\sum }_{k = 1}^{K} ( {α}_{m} + {\sum }_{d = 1}^{{D}^{′}} {γ}_{d} {g}_{d} ) {\overline{P}}_{mk} {Z}_{mk} = {Z}^{T} QZ + {r}^{T} Z \\ {where [ Q ]}_{mk , {m}^{′} {k}^{′}} = {P}_{mk} {{F}_{m {m}^{′}}^{{k}^{′}} [ r ]}_{mk} = ( {α}_{m} + {\sum }_{d = 1}^{{D}^{′}} {γ}_{d} {g}_{d} ) {\overline{P}}_{mk} & ( Expression 6 )\end{matrix}$$

Here, [Q]ᵢⱼ is the (i, j)-th element of a matrix Q, and [r]ᵢ is the i-th element of a vector r. Therefore, Q above is not a symmetric matrix, and is not positive-semidefinite. Accordingly, it is possible to transform the price optimization problem into BQP by discretely setting candidate prices.

Moreover, an optimization problem specified by Expression 5 above is to be solved by use of mixed-integer programming relaxation. In the case where a new variable Z_{i,j} with an overbar is used, a transformation process is performed as exemplified by Expression 7 below.

$$\begin{matrix} [ Math 12 ] & \\ max {\sum }_{i = 1}^{KM} ( {[ r ]}_{i} + {[ Q ]}_{i , i} ) {Z}_{i} + {\sum }_{i = 1}^{KM} {\sum }_{j = i + 1}^{KM} ( {[ Q ]}_{i , j} + {[ Q ]}_{j , i} ) {\overline{Z}}_{i , j} \\ s . t . {\sum }_{i = mK + 1}^{mK + K} {Z}_{i} = 1 ∀ m = 0 , … , M - 1 \\ {\overline{Z}}_{ij} \geq {Z}_{i} + {Z}_{j} - 1 ∀ i < j \\ {\overline{Z}}_{ij} \leq {Z}_{i} ∀ i < j \\ {\overline{Z}}_{ij} \leq {Z}_{j} ∀ i < j \\ {\overline{Z}}_{ij} \geq ∀ 1 \leq i \leq j \\ {\overline{Z}}_{i} ∈ \{ 0 , 1 \} ∀ i & ( Expression 7 )\end{matrix}$$

Here, a constraint represented by Expression 8 below is defined, in which the variable Z_{i,j} with an overbar has a value ZᵢZⱼ in an optimal solution.

$$\begin{matrix} [ Math 13 ] & \\ {\sum }_{i = mK + 1}^{j} {\overline{Z}}_{i , j} + {\sum }_{i = j + 1}^{mK + K} {\overline{Z}}_{j , i} = {\sum }_{i = mK + 1}^{mK + K} {Z}_{i} {Z}_{j} - {Z}_{j} = ( {\sum }_{i = mK + 1}^{mK + K} {Z}_{i} - 1 ) {Z}_{j} = 0 & ( Expression 8 )\end{matrix}$$

By addition of an equation represented as Expression 8 above, Expression 7 above can be newly formulated as Expression 9 cited below as an example.

$$\begin{matrix} [ Math 14 ] & \\ max {\sum }_{i = 1}^{KM} ( {[ r ]}_{i} + {[ Q ]}_{i , i} ) {Z}_{i} + {\sum }_{i = 1}^{KM} {\sum }_{j = i + 1}^{KM} ( {[ Q ]}_{i , j} + {[ Q ]}_{j , i} ) {\overline{Z}}_{i , j} \\ s . t . {\sum }_{i = mK + 1}^{mK + K} {Z}_{i} = 1 ∀ m = 0 , … , M - 1 \\ {\overline{Z}}_{ij} \geq {Z}_{i} + {Z}_{j} - 1 ∀ i < j \\ {\overline{Z}}_{ij} \leq {Z}_{i} ∀ i < j \\ {\overline{Z}}_{ij} \leq {Z}_{j} ∀ i < j \\ {\sum }_{i = mK + 1}^{j} {\overline{Z}}_{i , j} + {\sum }_{i = j + 1}^{mK + K} {\overline{Z}}_{j , i} = 0 \\ ∀ mK \leq j \leq mK + K , ∀ m = 0 , … , M - 1 \\ {\overline{Z}}_{ij} \geq 0 ∀ 1 \leq i \leq j \\ {Z}_{i} ∈ \{ 0 , 1 \} ∀ i & ( Expression 9 )\end{matrix}$$

It should be noted that in order to reduce the number of constraint conditions and improve the efficiency of calculation, the following inequality may be removed from the conditions of Expression 9 above.

Z̅ᵢⱼ≥Zᵢ+Zⱼ−1 [Math 15]

As described above, it can be said that an optimization problem for optimizing the price of each product so as to maximize total sales is a problem that can be formulated as the BQP represented by Expression 1 below.

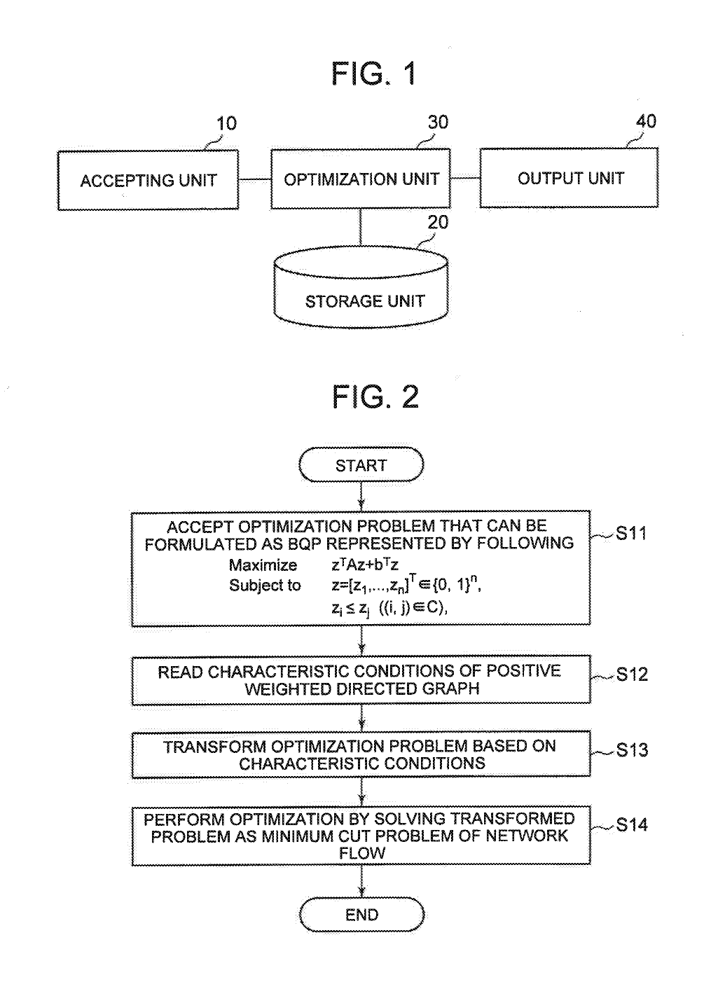

FIG. 1 depicts a block diagram illustrating a configuration example of the first exemplary embodiment of the optimization system according to the present invention. An optimization system 100 according to the present exemplary embodiment includes an accepting unit 10, a storage unit 20, an optimization unit 30, and an output unit 40.

The accepting unit 10 accepts an optimization problem that can be formulated as the BQP represented by Expression 1 above. Specifically, the accepting unit 10 accepts an optimization problem in which z of the BQP in Expression 1 satisfies the constraint conditions of Expression 1. As described above, the optimization problem for optimizing the price of each product can be formulated as the BQP represented by Expression 1 above. Therefore, the accepting unit 10 may accept an optimization problem for optimizing the prices of a plurality of products so as to maximize total sales, and one or more candidate prices as constraints.

It should be noted that an optimization problem to be accepted by the accepting unit 10 is not limited to the above. For example, the sum of products of a linear regression function and BQP having a 1-of-K constraint are also optimization problems that can be formulated as the BQP represented by Expression 1 above. Therefore, the accepting unit 10 may accept an optimization problem formulated by them.

The storage unit 20 stores constraint conditions for solving the accepted optimization problem. In the present exemplary embodiment, the storage unit 20 stores conditions (hereinafter referred to as characteristic conditions) representing characteristics of a positive weighted directed graph.

In the following description, a positive weighted directed graph is represented as G=(V, E, w). V is a set of finite vertices, and includes both a source (source vertex) s and a sink (sink vertex) t. E is a set of directed edges such that E⊆V×V. In addition, w is a positive capacity function of E (E→R_{>0}).

When N is the number of vertices, V and E in the present exemplary embodiment are each defined by Expression 10 below.

[Math 16]

V={s,t}␣N,

E={(i,j)∈N×N|aᵢⱼ≠0}∪{(i,t)∈N×{t}|i∈M₁}∪{(s,i)∈{s}×N|i∈M₂}∪C (Expression 10)

Here, M₁ and M₂ are sets of edges, and satisfy Expression 11 below.

$$\begin{matrix}[ Math 17 ] & \\ {M}_{1} = \{ i ∈ N \text{:} {b}_{i} + {\sum }_{j ∈ N \backslash \{ i \}} {a}_{ij} < 0 \} , \\ {M}_{2} = \{ i ∈ N \text{:} {b}_{i} + {\sum }_{j ∈ N \backslash \{ i \}} {a}_{ij} > 0 \} , & ( Expression 11 )\end{matrix}$$

In addition, values pᵢ and qᵢ given to each edge are each defined by Expression 12 below.

$$\begin{matrix}[ Math 18 ] & \\ {p}_{i} = - ( {b}_{i} + {\sum }_{j ∈ N \backslash \{ i \}} {a}_{ij} ) ( i ∈ {M}_{1} ) \\ {q}_{i} = {b}_{i} + {\sum }_{j ∈ N \backslash \{ i \}} {a}_{ij} ( i ∈ {M}_{2} ) & ( Expression 12 )\end{matrix}$$

Furthermore, a weight w(i, j) of each edge is defined by use of pᵢ and qᵢ, as Expression 13 below. Here, L is a constant determined by a user or the like.

$$\begin{matrix}[ Math 19 ] & \\ w ( i , j ) = \{ \begin{matrix}{a}_{ij} & ( i , j ∈ N , {a}_{ij} \neq 0 ) \\ {p}_{i} & ( i ∈ {M}_{1} , j = t ) \\ {q}_{j} & ( i = s , j ∈ {M}_{2} ) \\ L & ( ( i , j ) ∈ C )\end{matrix} & ( Expression 13 )\end{matrix}$$

In the present exemplary embodiment, the storage unit 20 stores characteristic conditions represented by Expressions 10 to 13 above. The storage unit 20 is implemented by, for example, a magnetic disk device.

The optimization unit 30 solves the accepted optimization problem. The optimization unit 30 according to the present exemplary embodiment transforms the accepted optimization problem based on the characteristic conditions stored in the storage unit 20. Then, the optimization unit 30 performs optimization by solving the transformed optimization problem as a minimum cut problem of a network flow. It should be noted that in the case where the accepted optimization problem has not been formulated as BQP, the optimization unit 30 may transform the optimization problem into BQP.

Additionally, in the present exemplary embodiment, a constraint represented by Expression 14 below is applied. In the case of optimization of product prices, this constraint (that is, au is non-negative) corresponds to the fact that respective products are in a competitive relationship (a reduction in the price of a product adversely affects sales of other products).

[Math 20]

aᵢⱼ≥0(i,j∈N) (Expression 14)

First, the optimization unit 30 transforms the BQP represented by Expression 1 above into Expression 15 below.

$$\begin{matrix}[ Math 21 ] & \\ \begin{matrix}{z}^{⊤} Az + {b}^{⊤} z = {\sum }_{i = 1}^{n} {\sum }_{j = 1}^{n} {a}_{ij} {z}_{i} {z}_{j} + {\sum }_{i = 1}^{n} {b}_{i} {z}_{i} \\ = {\sum }_{\{ i , j \} ⊆ N : i \neq j} 2 {a}_{ij} {z}_{i} {z}_{j} + {\sum }_{i ∈ N} {b}_{i} {z}_{i} \\ = - {\sum }_{\{ i , j \} ⊆ N : i \neq j} {{a}_{ij} ( {z}_{i} - {z}_{j} )}^{2} + \\ {\sum }_{\{ i , j \} ⊆ N : i \neq j} {a}_{ij} ( {z}_{i}^{2} + {z}_{j}^{2} ) + {\sum }_{i ∈ N} {b}_{i} {z}_{i} \\ = - {\sum }_{\{ i , j \} ⊆ N : i \neq j} {{a}_{ij} ( {z}_{i} - {z}_{j} )}^{2} + \\ {\sum }_{\{ i , j \} ⊆ N : i \neq j} {a}_{ij} ( {z}_{i} + {z}_{j} ) + {\sum }_{i ∈ N} {b}_{i} {z}_{i} \\ = - {\sum }_{\{ i , j \} ⊆ N : i \neq j} {{a}_{ij} ( {z}_{i} - {z}_{j} )}^{2} - {\sum }_{i ∈ {M}_{1}} {p}_{i} {z}_{i} - \\ {\sum }_{i ∈ {M}_{2}} {q}_{i} ( 1 - {z}_{i} ) + {\sum }_{i ∈ {M}_{2}} {q}_{i}\end{matrix} & ( Expression 15 )\end{matrix}$$

Then, the optimization unit 30 transforms Expression 15 above obtained by transformation of the accepted optimization problem, based on the characteristic conditions stored in the storage unit 20. Specifically, the optimization unit 30 transforms the optimization problem into Expression 16 below.

$$\begin{matrix} [ Math 22 ] & \\ - {c}_{G} ( \{ s \} ⋃ \{ i ∈ N \vert {z}_{i} = 1 \} ) + {\sum }_{i ∈ {M}_{2}} {q}_{i} = {z}^{⊤} Az + {b}^{⊤} z - L \vert \{ ( i , j ) ∈ C \vert {z}_{i} > {z}_{j} \} \vert & ( Expression 16 )\end{matrix}$$

Here, a relationship between U and z is defined by Expression 17 below.

[Math 23]

U={s}∪{i∈N|zᵢ=1} (Expression 17)

In this case, if L is defined as a sufficiently large value, a minimum cut problem (c_{G}(U), where U is an s-t cut) of a positive weighted directed graph G represented by Expression 18 below, is equivalent to an optimization problem represented by Expression 19 below. That is, an optimal solution and an optimal value of the minimum cut problem agree with those of the problem represented by Expression 1 above.

[Math 24]

Minimize c_{G}(U)

subject to U:s−t cut (Expression 18)

Maximize z^{T}Az+b^{T}z−L|{(i,j)∈C|zᵢ>zⱼ}|

subject to z=[z₁, . . . ,zₙ]^{T}∈{0,1}ⁿ, (Expression 19)

As described above, the optimization unit 30 solves the accepted optimization problem by solving the problem transformed from the BQP, as a minimum cut problem of a network flow. Therefore, optimization can be performed more efficiently than in the case of general BQP optimization.

The output unit 40 outputs a result of optimization. For example, in the case where the optimization unit 30 has solved an optimization problem for optimizing prices of a plurality of products so as to maximize total sales with accepted one or more candidate prices as constraints, the output unit 40 may output the price of each product obtained as an optimal solution.

The accepting unit 10, the optimization unit 30, and the output unit 40 are implemented by a CPU of a computer that operates according to a program (optimization program). For example, it is possible to adopt the following configuration. The program is stored in the storage unit 20. The CPU reads the program, and operates as the accepting unit 10, the optimization unit 30, and the output unit 40 according to the program. In addition, each of the accepting unit 10, the optimization unit 30, and the output unit 40 may be implemented by dedicated hardware.

Furthermore, a part or all of each constituent element of each device may be implemented by general-purpose or dedicated circuitry, a processor, or the like, or by a combination thereof. These may be constituted by a single chip, or may be constituted by a plurality of chips connected via a bus. A part or all of each constituent element of each device may be implemented by a combination of the above-described circuitry or the like and a program.

Moreover, in the case where a part or all of each constituent element of each device is implemented by a plurality of information processors, circuitry, and the like, the plurality of information processors, circuitry, and the like may be arranged in a centralized manner or in a decentralized manner. For example, an information processor, circuitry, or the like may be implemented in various forms such as a client server system and a cloud computing system, each of which is connected via a communication network.

Next, operation of the optimization system according to the present exemplary embodiment will be described. FIG. 2 depicts a flowchart illustrating an operation example of the optimization system 100 according to the first exemplary embodiment. First, the accepting unit 10 accepts an optimization problem that can be formulated as the BQP represented by Expression 1 above (step S11).

The optimization unit 30 reads characteristic conditions representing characteristics of a positive weighted directed graph, stored in the storage unit 20 (step S12).

Then, the optimization unit 30 transforms the accepted optimization problem based on the characteristic conditions (step S13), and solves the accepted optimization problem by solving the transformed problem as a minimum cut problem of a network flow (step S14).

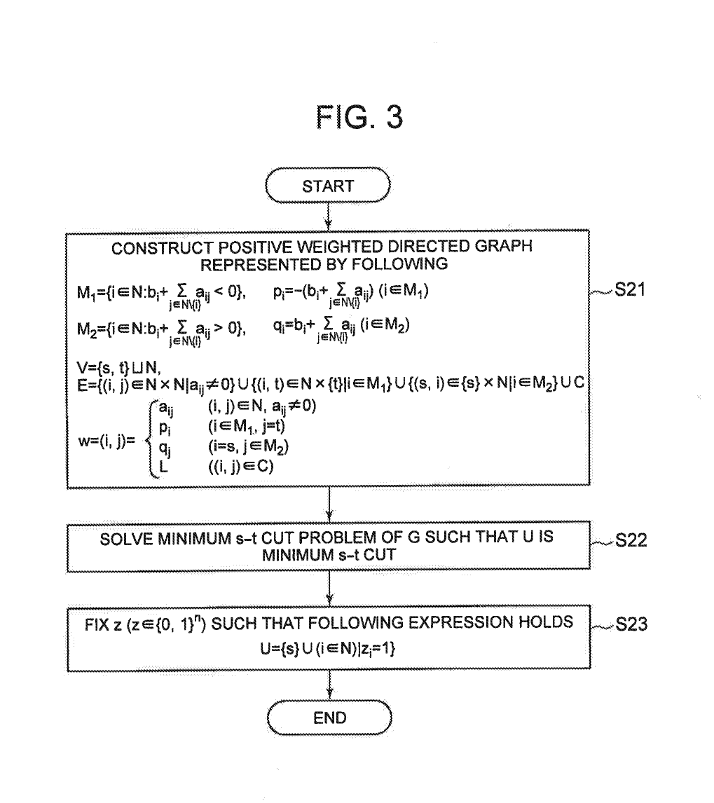

FIG. 3 depicts a flowchart illustrating an operation example of the optimization unit 30. The optimization unit 30 reads the characteristic conditions represented by Expressions 10 to 13 above, as the characteristic conditions representing characteristics of a positive weighted directed graph, stored in the storage unit 20. As a result, the optimization unit 30 constructs the positive weighted directed graph G as represented by Expressions 10 to 13 above stored in the storage unit 20 (step S21).

Next, the optimization unit 30 solves a minimum s-t cut problem of G such that U is a minimum s-t cut (step S22). Then, the optimization unit 30 fixes z (z∈{0, 1}ⁿ) such that Expression 17 above holds (step S23).

As described above, in the present exemplary embodiment, an optimization problem is solved as follows. The accepting unit 10 accepts an optimization problem that can be formulated as the BQP represented by Expression 1 above. The optimization unit 30 transforms the accepted optimization problem based on the characteristic conditions representing the characteristics of the positive weighted directed graph Q and solves the accepted optimization problem by solving the transformed problem as a minimum cut problem of a network flow. Thus, the optimization system according to the present exemplary embodiment operates in a manner different from that of a general computer that performs a BQP optimization process. Accordingly, an optimization process can be performed more efficiently.

That is, it can also be said that the present invention achieves an information processor as an optimization system, in which not a simple BQP optimization device but a device (for example, a CPU) capable of solving a minimum cut problem of a network flow collaborates with the storage unit 20 that stores the characteristic conditions of a positive weighted directed graph. Therefore, compared to a general device that solves BQP, performance of a computer is remarkably improved.

It should be noted that in the description of the present exemplary embodiment, the optimization system has been applied to the case of determining the prices of products in a manner to maximize total sales. In addition, the optimization system according to the present exemplary embodiment may be applied to, for example, the case of optimizing shelf allocation of products. For example, let P be the price of a product, H be a position on a shelf, and θₘ be a parameter. Then, a prediction model of the sales quantity Sₘ of the product m can be represented by, for example, the following linear regression model.

Sₘ=linear_regression(P,H,θₘ)

Then, the optimization unit 30 just needs to optimize P and H so as to maximize sales (specifically, the sum of products of the price Pₘ of the product m and the sales quantity Sₘ). Furthermore, any given business constraints (for example, price terms) may also be set in this case.

In addition to the above-described shelf allocation, the optimization system of the present invention can also be applied to optimization of an objective function represented by products of the prices of objects to be sold (including both services and products) and demand for the objects to be sold (a function of prices of a plurality of objects to be sold). Examples of optimization of such an objective function include retail price optimization, hotel room price optimization, airline ticket price optimization, parking fee optimization, and campaign optimization.

### Second Exemplary Embodiment

Next, a second exemplary embodiment of the optimization system according to the present invention will be described. The configuration of the second exemplary embodiment is similar to that of the first exemplary embodiment. In the first exemplary embodiment, the case where the accepting unit 10 accepts an optimization problem that can be formulated as the BQP represented by Expression 1 above has been described.

Here, when an optimization problem satisfies a constraint represented by Expression 20 below in addition to the constraint represented by Expression 1 above, Expression 1 above can be solved more efficiently. Therefore, in the present exemplary embodiment, description will be provided with respect to an optimization method to be performed by an optimization unit 30 in the case where the constraint represented by Expression 20 below is satisfied.

[Math 25]

zₙ_{₁}≤zₙ_{₂}≤ . . . ≤zₙ_{ₖ}≤zₙ_{₁} (Expression 20)

First, a directed graph H=(N, C) is defined. In the present exemplary embodiment, N represents a set of vertices, and C represents a set of edges. If a directed graph includes a directed closed cycle n₁, n₂, . . . , nₖ, and n₁ constituted by vertices included in N, the problem of Expression 1 above includes the constraint of Expression 20 above. That is, this means zₙ₁=zⁿ² . . . =zₙₖ.

Only when n₁, n₂, . . . , and nₖ are included in a strongly connected component of H, n₁, n₂, . . . , nₖ, and n₁ constitute a directed closed cycle. Therefore, variables included in the same connected component need to have the same values. Accordingly, decomposition of strongly connected components of H is given by Expression 21 below.

$$\begin{matrix} [ Math 26 ] & \\ \{ {N}_{1} , … , {N}_{K} \} ⊆ {2}^{N} ( k \neq l {N}_{k} ⋂ {N}_{l} = ∅ , {{⋃}^{K}}_{k = 1} {N}_{k} = N ) & ( Expression 21 )\end{matrix}$$

Thus, it is possible to reduce the BQP of Expression 1 above to smaller BQP by regarding a set of variables of each Nₖ as a single variable. The reduced BQP is represented by the Expression 22 below.

[Math 27]

Maximize z^{T}A′z+b′^{T}z

subject to z=[z₁, . . . ,z_{K}]^{T}∈{0,1}^{K},

zᵢ≤zⱼ((i,j)∈C′), (Expression 22)

In Expression 22, A′ is a K×K square matrix, and b′ is a K-dimensional vector. In addition, C′ is defined by C′⊆{1, . . . , K}×{1, . . . , K}. It should be noted that A′, b′, and C′ are defined by Expressions 23 and 24 below.

$$\begin{matrix}[ Math 28 ] & \\ {A}^{′} [ k , l ] = {\sum }_{i ∈ {N}_{k} , j ∈ {N}_{l}} A [ i , j ] , {b}^{′} [ k ] = {\sum }_{i ∈ {N}_{k}} b [ i ] & ( Expression 23 ) \\ ( k , l ) ∈ {C}^{′} ∃ i ∈ {N}_{k} , ∃ j ∈ {N}_{l} , ( i , j ) ∈ C & ( Expression 24 )\end{matrix}$$

As a result of defining decomposition of strongly connected components in the above-described manner, no directed closed cycle is included in a directed graph given by a set of vertices {1, . . . K} and a set of edges C′. Therefore, it may be assumed, without loss of generality, that H is an acyclic graph.

Here, it is possible to replace A in Expression 1 above with (A+A^{T})/2. This is because z^{T}Az=z^{T} (A+A^{T}) z/2 holds for all z (z∈Rₙ). Therefore, it may be assumed, without loss of generality, that A is a symmetric matrix.

An objective function of the problem represented by Expression 1 above is represented by Expression 25 below.

$$\begin{matrix}[ Math 29 ] & \\ {z}^{⊤} Az + {b}^{⊤} z = {\sum }_{i = 1}^{n} {\sum }_{j = 1}^{n} {a}_{ij} {z}_{i} {z}_{j} + {\sum }_{i = 1}^{M} {b}_{i} {z}_{i} . & ( Expression 25 )\end{matrix}$$

For each zᵢ∈(0, 1), zᵢzᵢ=zᵢ holds. Furthermore, if zᵢ≤zⱼ, the following is obtained: zᵢzⱼ=zᵢ. Therefore, with respect to a feasible solution z of the problem represented by Expression 1 above, the value of the objective function does not change even after replacing A and b with A′ and b′, respectively. Here, A′ and b′ having replaced A and b, respectively, are defined by Expressions 26 and 27 below.

$$\begin{matrix}[ Math 30 ] & \\ {a}_{ij}^{′} = \{ \begin{matrix}0 & ( i = j ) \\ 0 & ( j ∈ {P}_{i} ) \\ 0 & ( i ∈ {P}_{j} ) \\ {a}_{ij} & ( otherwise )\end{matrix} & ( Expression 26 ) \\ {b}_{i}^{′} = {b}_{i} + {a}_{ii} + {\sum }_{j ∈ {P}_{i}} ( {a}_{ij} + {a}_{ji} ) & ( Expression 27 )\end{matrix}$$

Here, Pᵢ⊆N is given by Expression 28 below.

[Math 31]

Pᵢ={j∈N\{i}|H has a directed path from i to j} (Expression 28)

As a result of replacing A and b in the above-described manner, it is possible to reduce the number of nonzero elements among the elements of A. It is thus possible to reduce the complexity of a problem. That is, the optimization unit 30 optimizes a problem transformed in the above-described manner. Accordingly, the optimization unit 30 can perform optimization more efficiently.

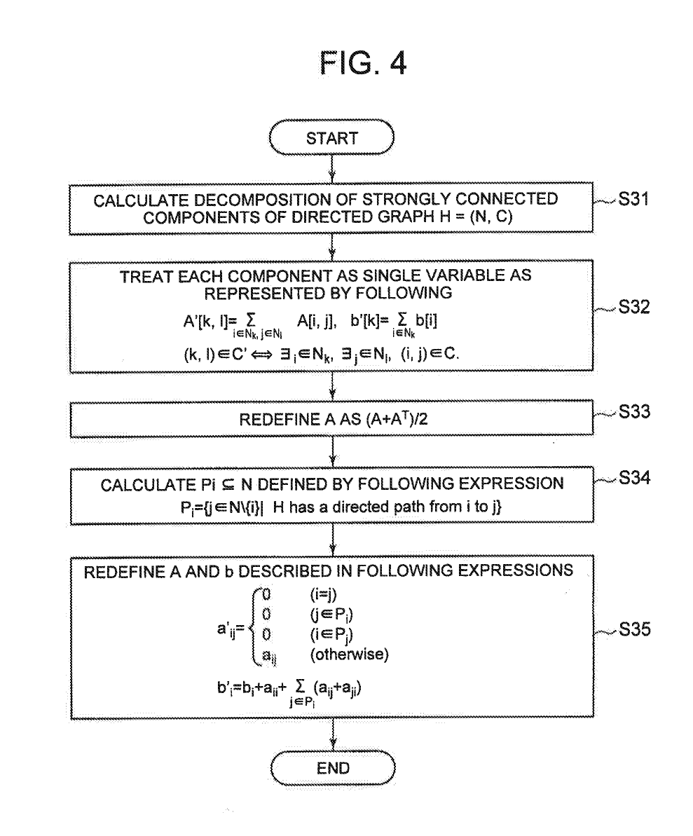

Next, operation of the optimization system according to the present exemplary embodiment will be described. FIG. 4 depicts a flowchart illustrating an operation example of the optimization unit 30 according to the present exemplary embodiment. The optimization unit 30 calculates decomposition of strongly connected components of the directed graph H=(N, C) (step S31), and treats each component as a single variable, as represented by Expressions 23 and 24 above (step S32). The optimization unit 30 symmetrizes the matrix A. That is, the optimization unit 30 redefines A as (A+A^{T})/2 (step S33). The optimization unit 30 calculates Pi⊆N defined by Expression 28 above (step S34), and redefines A and b described in Expressions 26 and 27 above (step S35).

As described above, in the present exemplary embodiment, A and b of the problem of Expression 1 above are redefined by decomposition of the strongly connected components of the directed graph H under the constraint represented by Expression 20 above. As a result of such redefinition, it is possible to reduce the complexity of a problem. Thus, optimization can be performed more efficiently.

Furthermore, even in the case where the constraint represented by Expression 14 above is not satisfied, the constraint represented by Expression 14 above may possibly be satisfied as a result of redefining A and b as described in the present exemplary embodiment.

It should be noted that, for example, in Tarjan's algorithm, strongly connected components are calculated in the order of O(n+|C|). In order to calculate more efficiently, the optimization unit 30 may calculate {Pᵢ}ⁿᵢ₋₁ by using properties represented in Expression 29 below.

$$\begin{matrix}[ Math 32 ] & \\ {P}_{i} = {⋃}_{j : ( i , j ) ∈ C} {P}_{j} ⋃ \{ j \} & ( Expression 29 )\end{matrix}$$

### Third Exemplary Embodiment

Next, a third exemplary embodiment of the optimization system according to the present invention will be described. The configuration of the third exemplary embodiment is also similar to that of the first exemplary embodiment. In the first exemplary embodiment, the case where the optimization unit 30 solves BQP that satisfies the constraint represented by Expression 14 above has been described. That is, if aᵢⱼ<0 for any given i and j, the optimization unit 30 cannot optimize the problem represented by Expression 1 above by using the method described in the first exemplary embodiment. Therefore, in the present exemplary embodiment, a method for finding an approximate optimal solution even in such a case (in the case where there exist i and j such that aᵢⱼ<0) will be described.

In the present exemplary embodiment, aᵢⱼzᵢzⱼ is approximated by linear terms represented by Expression 30 below. It should be noted that in Expression 30, the following is satisfied: 0≤α≤1.

[Math 33]

zᵢzⱼ≈α(zᵢ+zⱼ−1) (Expression 30)

Here, decomposing the matrix A into A⁺∈R^{n×n}_{≥0} and A⁻∈R^{n×n}_{≥0} will be considered. Specifically, if A⁺=(aᵢⱼ⁺)∈R^{n×n} and A⁻=(aᵢⱼ⁺)∈R^{n×n} such that aᵢⱼ⁺ and aᵢⱼ⁻ are given by Expression 31 below, an optimization unit 30 decomposes A such that A⁺−A⁻=A.

$$\begin{matrix}[ Math 34 ] & \\ {a}_{ij}^{+} = \{ \begin{matrix}{a}_{ij} & ( {a}_{ij } \geq 0 ) \\ 0 & ( {a}_{ij} < 0 )\end{matrix} , \\ {a}_{ij}^{-} = \{ \begin{matrix}0 & ( {a}_{ij} \geq 0 ) \\ - {a}_{ij} & ( {a}_{ij} < 0 )\end{matrix} ( i , j ∈ N ) & ( Expression 31 )\end{matrix}$$

In this case, the objective function of the problem represented by Expression 1 above is represented by Expression 32 below.

[Math 35]

z^{T}Az+b^{T}z=z^{T}A⁺z+b^{T}z−z^{T}A⁻z (Expression 32)

Any given real value α∈[0, 1] satisfies Expression 33 below.

[Math 36]

α(zᵢ+zⱼ−1)≤zᵢzⱼ (zᵢ,zⱼ∈{0,1}) (Expression 33)

Therefore, any given B=(bᵢⱼ)∈R_{≥o} that satisfies Expression 34 below also satisfies Expression 35 below.

[Math 37]

0≤bᵢⱼ≤aᵢⱼ⁻ (i,j∈N) (Expression 34)

[Math 38]

2·1^{T}Bz−1^{T}B1≤z^{T}A⁻z (z∈{0,1}ⁿ) (Expression 35)

Accordingly, an optimal value of a problem represented by Expression 36 below is an upper bound of the optimal value of the problem represented by Expression 1 above.

[Math 39]

Maximize z^{T}A⁺z+(b−2B1)^{T}z+1^{T}B1

subject to z=[z₁, . . . ,zₙ]^{T}∈{0,1}ⁿ,

zᵢ≤zⱼ ((i,j)∈C) (Expression 36)

Here, define B=A⁻/2. Then, as a result of subtracting the objective function of Expression 1 above from an objective function of Expression 36 above, a function represented by Expression 37 below is obtained.

$$\begin{matrix}[ Math 40 ] & \\ \frac{1}{2} ( {z}^{⊤} {A}^{-} z + {( 1 - z )}^{⊤} {A}^{-} ( 1 - z ) ) \leq \frac{1}{2} {1}^{⊤} {A}^{-} 1 & ( Expression 37 )\end{matrix}$$

Here, let z+ be an optimal solution of the objective function of Expression 1 above, and z with a superscript tilde be an optimal solution of the objective function of Expression 36 above. Then, a relationship represented by Expression 38 below is guaranteed, accordingly.

$$\begin{matrix} [ Math 41 ] & \\ {z}_{*}^{⊤} {Az}_{*} + {b}_{z *}^{⊤} \leq {z}_{z *}^{⊤} {A}^{+} {z}_{*} + {( b - 2 B 1 )}^{⊤} {z}_{*} + {1}^{⊤} B 1 \leq {\tilde{z}}^{⊤} {A}^{+} \tilde{z} + {( b - 2 B 1 )}^{⊤} \tilde{z} + {1}^{⊤} B 1 = {\tilde{z}}^{⊤} A \tilde{z} + {b}^{⊤} \tilde{z} + \frac{1}{2} ( {\tilde{z}}^{⊤} {A}^{-} \tilde{z} + {( 1 - \tilde{z} )}^{⊤} {A}^{-} ( 1 - \tilde{z} ) ) \leq {\tilde{z}}^{⊤} A \tilde{z} + {b}^{⊤} \tilde{z} + \frac{1}{2} {1}^{⊤} {A}^{- 1} 1. & ( Expression 38 )\end{matrix}$$

It is clear from the discussion above that there exists a polynomial time algorithm for calculating a feasible solution of the problem of Expression 1 above, as follows.

\tilde{z}^{T}A\tilde{z}+b^{T}\tilde{z}≥z_{*}^{T}Az_{*}+b^{T}z_{*}−½·1^{T}A⁻1 [Math 42]

Therefore, the optimization unit 30 according to the present exemplary embodiment calculates an approximate solution of an accepted optimization problem by solving the problem represented by Expression 36 above as a minimum cut problem of a network flow.

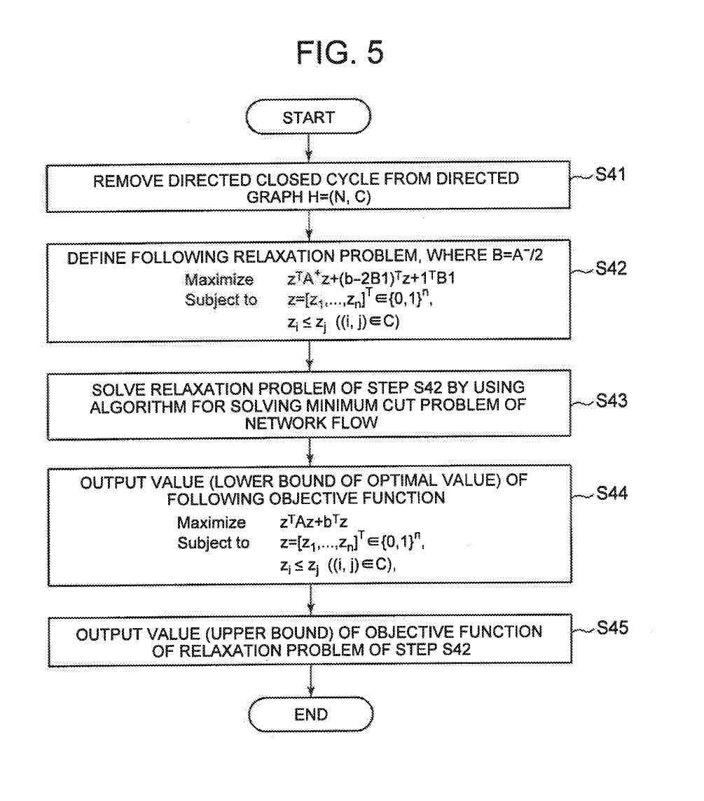

Next, operation of the optimization system according to the present exemplary embodiment will be described. FIG. 5 depicts a flowchart illustrating an operation example of the optimization unit 30 according to the present exemplary embodiment. First, the optimization unit 30 removes a directed closed cycle from the directed graph H=(N, C) (step S41), and reduces quadratic terms. Next, the optimization unit 30 defines a relaxation problem of Expression 36 above, where B=A⁻/2 (step S42).

Then, the optimization unit 30 solves the problem of Expression 36 above by using the method for solving a minimum cut problem of a network flow described in the first exemplary embodiment (more specifically, the method illustrated in the flowchart of FIG. 3). As a result, the optimization unit 30 obtains z with a superscript hat (hereinafter, simply referred to as “z hat”) as an optimal solution of Expression 36 above (step S43).

Subsequently, an output unit 40 outputs z hat and a value of the objective function of the problem of Expression 1 above concerning z hat (a lower bound of the optimal value of the problem of Expression 1 above) (step S44), and also outputs the value of Expression 36 above (upper bound) (step S45).

As described above, in the present exemplary embodiment, the optimization unit 30 optimizes the problem represented by Expression 1 above by relaxing this problem to the problem represented by Expression 36. Therefore, even in the case where the constraint represented by Expression 14 above is not satisfied, it is possible to find an approximate value of the optimal solution of the problem of Expression 1 above in polynomial time.

Next, a variation of the optimization system of the present exemplary embodiment will be described. In the third exemplary embodiment, a method for calculating an approximate value based on an algorithm exemplified in FIG. 5 has been described. In the present variation, a dual problem of the problem represented by Expression 1 above is considered. Described below is a method for finding a more appropriate solution than that based on the algorithm exemplified in FIG. 5, by repeatedly solving a minimum cut problem while changing weights in a network.

Expression 39 defines φ: {0, 1}ⁿ×[0, 1]^{n×n}→R as follows.

[Math 43]

ϕ(z,B)=z^{T}A⁺z+b^{T}z−1^{T}(A⁻oB)z−z_{T}(A⁻oB)1+1T(A⁻oB)1 (Expression 39)

In Expression 39, A⁻oB represents a Hadamard product, that is, (A⁻oB)ᵢⱼ=(A⁻)_{ij′}(B)ᵢⱼ. In addition, since a relationship represented by Expression 40 below is satisfied, Expression 41 below is obtained for φ.

$$\begin{matrix} [ Math 44 ] & \\ max \{ α ( {z}_{i} + {z}_{j} - 1 ) \vert α ∈ [ 0 , 1 ] \} = {z}_{i} {z}_{j} ( {z}_{i} , {z}_{j} ∈ \{ 0 , 1 \} ) & ( Expression 40 ) \\ {min}_{B ∈ {[ 0 , 1 ]}^{n \times n}} φ ( z , B ) = {z}^{⊤} Az + {b}^{⊤} z & ( Expression 41 )\end{matrix}$$

Here, let R be a feasible solution of the problem of Expression 1 above. Then, an optimal value of Expression 1 above is represented by Expression 42 below.

$$\begin{matrix}[ Math 45 ] & \\ {max}_{z ∈ R} {min}_{B ∈ {[ 0 , 1 ]}^{n \times n}} φ ( z , B ) & ( Expression 42 )\end{matrix}$$

Here, Expression 43 below holds. Therefore, an optimization unit 30 can obtain an upper bound of the optimal value of the problem of Expression 1 above by solving a problem represented by Expression 44 below. It should be noted that ψ: [0, 1]^{n×n}→R is defined by Expression 45 below.

$$\begin{matrix}[ Math 46 ] & \\ {max}_{z ∈ R} {min}_{B ∈ {[ 0 , 1 ]}^{n \times n}} φ ( z , B ) \leq {min}_{B ∈ {[ 0 , 1 ]}^{n \times n}} {max}_{z ∈ R} φ ( z , B ) & ( Expression 43 ) \\ Minimize ψ ( B ) \\ subject to B ∈ {[ 0 , 1 ]}^{n \times n} & ( Expression 44 ) \\ ψ ( B ) = {max}_{z ∈ R} φ ( z , B ) & ( Expression 45 ) \end{matrix}$$

For a given B, the optimization unit 30 calculates z*∈ argmax_{z} φ(z, B) and ψ(B). Furthermore, the optimization unit 30 calculates ∇_{Bφ}(z*, B) by using Expression 46 below.

[Math 47]

∇Bϕ(z*,B)=A⁻o(11^{T}−z*1^{T}−1z*^{T}) (Expression 46)

Then, it is guaranteed that an optimal solution of the problem represented by Expression 44 above is within a range represented by Expression 47 below.

[Math 48]

{B′∈[0,1]^{n×n}|∇_{B}ϕ(z*,B)·(B′−B)≤0} (Expression 47)

Therefore, the optimization unit 30 can construct the ellipsoid method for the problem of Expression 44 above. This means that the problem of Expression 44 above can be solved in polynomial time. Therefore, the optimization unit 30 optimizes Expression 1 above based on the constructed ellipsoid method.

It should be noted that actually, the ellipsoid method is slow. Therefore, the optimization unit 30 may use a simpler gradient descent algorithm with respect to B. In this case, the optimization unit 30 defines a search method Sₜ for each step t by Expressions 48 and 49 below.

$$\begin{matrix}[ Math 49 ] & \\ {\tilde{S}}_{t} = - {∇}_{{B}_{t}} φ ( {z}_{t} , {B}_{t} ) = - {A}^{-} ∘ ( {11}^{⊤} - {z}_{t} {1}^{⊤} - 1 {z}_{t}^{⊤} ) & ( Expression 48 ) \\ {S}_{t} [ i ] [ j ] = \{ \begin{matrix}0 & ( {\tilde{S}}_{t} [ i ] [ j ] > 0 , {B}_{t} [ i ] [ j ] = 1 ) \\ 0 & ( {\tilde{S}}_{t} [ i ] [ j ] < 0 , {B}_{t} [ i ] [ j ] = 0 ) \\ {\tilde{S}}_{t} [ i ] [ j ] & otherwise\end{matrix} & ( Expression 49 ) \end{matrix}$$

In addition, the optimization unit 30 defines a step size ηₜ by Expression 50 below. It should be noted that in Expression 50, s is defined by s=t+(constant).

$$\begin{matrix}[ Math 50 ] & \\ {η}_{t} = \frac{1}{\sqrt{s} \cdot {max}_{i , j} \{ \vert {S}_{t} [ i ] [ j ] \vert \}} & ( Expression 50 )\end{matrix}$$

Then, Proj_{[0, 1]}(B) is defined by Expression 51 below.

$$\begin{matrix}[ Math 51 ] & \\ {Proj}_{[ 0 , 1 ]} ( B ) [ i ] [ j ] = \{ \begin{matrix}0 & ( B [ i ] [ j ] < 0 ) \\ 1 & ( B [ i ] [ j ] > 1 ) \\ B [ i ] [ j ] & ( otherwise )\end{matrix} & ( Expression 51 )\end{matrix}$$

With the above-described definition, the optimization unit 30 can optimize Expression 1 above by using the gradient descent algorithm.

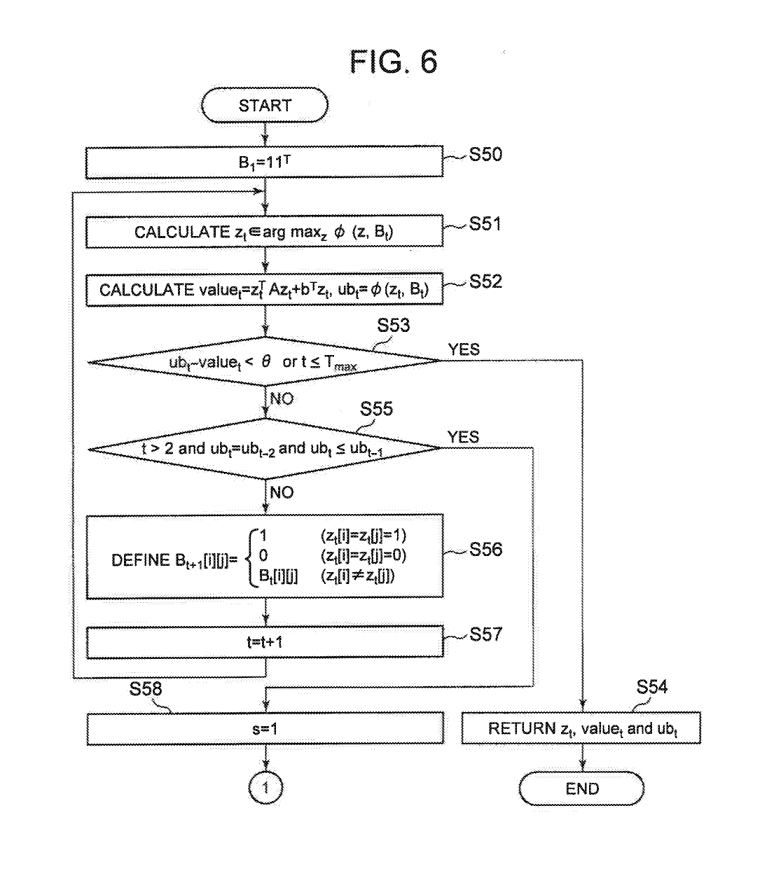

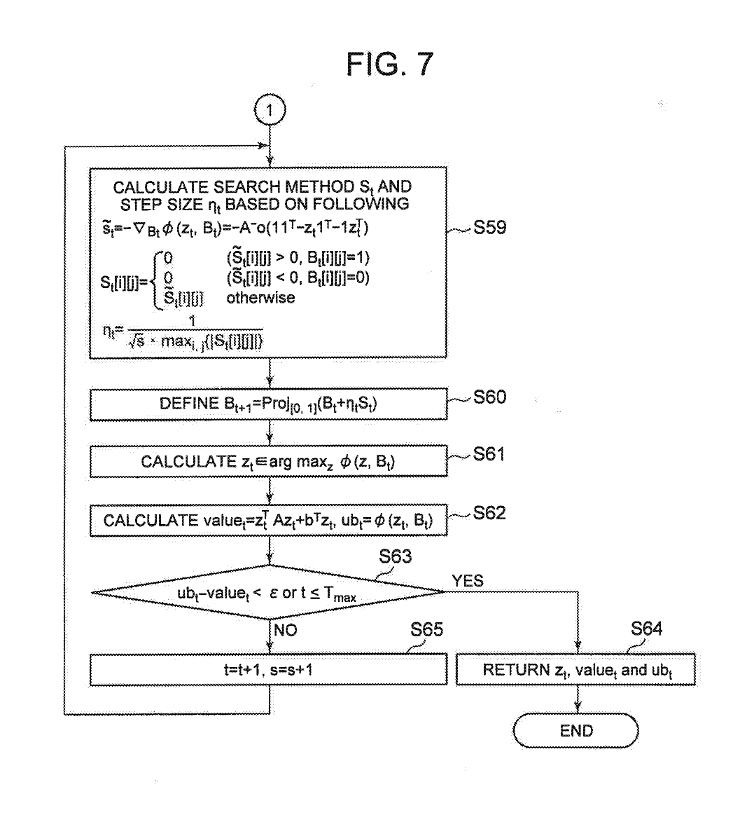

Next, operation of an optimization system according to the present variation will be described. FIGS. 6 and 7 depict flowcharts illustrating operation examples of the optimization unit 30 according to the present variation. First, B₁ is defined by Expression 52 below (step S50). Then, the optimization unit 30 repeats processes from step S51 to step S57 as follows.

[Math 52]

B₁=11^{T} (Expression 52)

First, the optimization unit 30 calculates zₜ∈ argmax_{z} φ(z, Bₜ) by using an algorithm used to solve the optimization problem in the first exemplary embodiment (specifically, an algorithm exemplified in the flowchart of FIG. 2)) (step S51). In addition, the optimization unit 30 calculates valueₜ and ubₜ by using Expression 53 below (step S52).

[Math 53]

valueₜ=zₜ^{T}Azₜ+b^{T}zₜ, ubₜ=ϕ(zₜ,Bₜ) (Expression 53)

If a difference between ubₜ and valueₜ calculated as described above is smaller than a predetermined value ∈, or if t is equal to or smaller than a predetermined maximum value Tₘₐₓ (YES in step S53), the optimization unit 30 treats zₜ, valueₜ, and ubₜ as calculation results (step S54).

Meanwhile, in the case of NO in step S53, if t>2, ubₜ=ubₜ₋₂, and ubₜ≤ubₜ₋₁ (YES in step S55), the process exits the loop, and proceeds to step S58. In contrast, in the case of NO in step S55, the optimization unit 30 defines Bₜ₊₁ by Expression 54 below (step S56). Then, the optimization unit 30 increments t by one (step S57), and repeats the processes from step S51.

$$\begin{matrix}[ Math 54 ] & \\ {B}_{t + 1} [ i ] [ j ] = \{ \begin{matrix}1 & ( {z}_{t} [ i ] = {z}_{t} [ j ] = 1 ) \\ 0 & ( {z}_{t} [ i ] = {z}_{t} [ j ] = 0 ) \\ {B}_{t} [ i ] [ j ] & ( {z}_{t} [ i ] \neq {z}_{t} [ j ] )\end{matrix} & ( Expression 54 )\end{matrix}$$

After exiting the loop from step S51 to step S57, the optimization unit 30 sets s to 1 (step S58). Subsequently, the optimization unit 30 repeats processes from step S59 to step S65 as follows.

First, the optimization unit 30 calculates the search method Sₜ and the step size ηₜ by using Expressions 48 to 50 above (step S59 in FIG. 7). Next, the optimization unit 30 defines Bₜ₊₁ by Expression 55 below (step S60).

[Math 55]

Bₜ₊₁=Proj_{[0,1]}(Bₜ+ηₜSₜ) (Expression 55)

The optimization unit 30 calculates zₜ∈ argmax_{z} φ(z, Bₜ) by using the algorithm used to solve the optimization problem in the first exemplary embodiment (specifically, the algorithm exemplified in the flowchart of FIG. 2)) (step S61). In addition, the optimization unit 30 calculates valueₜ and ubₜ by using Expression 53 above (step S62).

If a difference between ubₜ and valueₜ calculated as described above is smaller than the predetermined value ∈, or if t is equal to or smaller than the predetermined maximum value Tₘₐₓ (YES in step S63), the optimization unit 30 treats zₜ, valueₜ, and ubₜ as calculation results (step S64).

Meanwhile, in the case of NO in step S63, the optimization unit 30 increments each oft and s by one (step S65), and repeats processes in step S59 and subsequent steps.

As described above, in the present variation, the dual problem of the problem represented by Expression 1 above is considered, and the optimization unit 30 repeatedly solves a minimum cut problem while changing weights in a network. Therefore, while it takes more calculation time than the method using the algorithm exemplified in FIG. 5, it is possible to find a more appropriate solution.

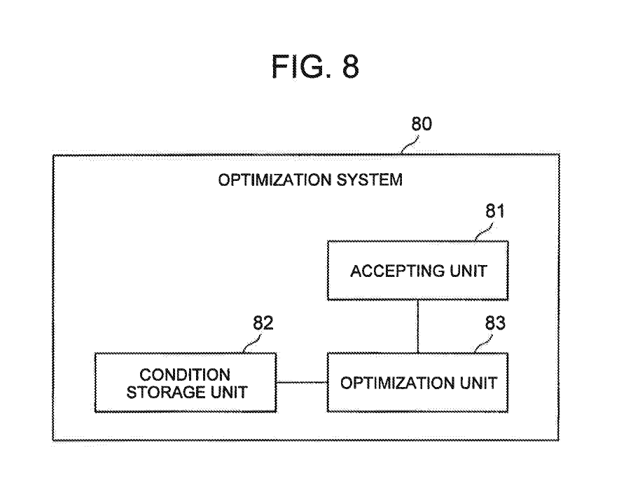

Next, an outline of the present invention will be described. FIG. 8 depicts a block diagram illustrating an outline of the optimization system according to the present invention. An optimization system 80 (for example, the optimization system 100) according to the present invention includes an accepting unit 81 (for example, the accepting unit 10), a condition storage unit 82 (for example, the storage unit 20), and an optimization unit 83 (for example, the optimization unit 30). The accepting unit 81 accepts an optimization problem (for example, Expression 1 above) that can be formulated as BQP represented by Expression A above by use of the n×n square matrix A and the n-dimensional vector b. The condition storage unit 82 stores characteristic conditions (for example, the characteristic conditions represented by Expressions 10 to 13 above) representing characteristics of a positive weighted directed graph (for example, G=(V, E, w)). The optimization unit 83 solves the accepted optimization problem.

The accepting unit 81 accepts an optimization problem in which the BQP in Expression A satisfies constraints represented by Expression B above in the case where C is defined as an N× N combination. The optimization unit 83 transforms the optimization problem based on the characteristic conditions, and solves the accepted optimization problem by solving the transformed problem as a minimum cut problem of a network flow.

With such a configuration, it is possible to perform BQP optimization more efficiently.

Specifically, the condition storage unit 82 may store the characteristic conditions represented by Expressions 10 and 13 above in the case where Expressions 11 and 12 above are defined such that aᵢⱼ is an element of A, and bᵢ is an element of b.

In addition, the accepting unit 81 may accept an optimization problem for optimizing the prices of a plurality of products so as to maximize total sales, and one or more candidate prices as constraints. The optimization unit 83 may solve the optimization problem under the accepted constraints. In such a case, it is possible to solve a price optimization problem at higher speed.

Furthermore, the optimization unit may solve the accepted optimization problem under the constraint where all the elements of the square matrix A are non-negative (for example, the constraint represented by Expression 14 above).

The present invention has been described above with reference to the exemplary embodiments and examples. However, the present invention is not limited to the above-described exemplary embodiments and examples. Various changes that can be understood by those skilled in the art can be made to the configurations and details of the present invention, within the scope of the present invention.

The present application claims priority based on U.S. Provisional Application No. 62/338,020, filed on May 18, 2016, the disclosure of which is incorporated herein by reference in its entirety.

### REFERENCE SIGNS LIST

10 accepting unit
20 storage unit
30 optimization unit
40 output unit

1. An optimization system comprising:
a hardware including a processor;
an accepting unit, implemented by the processor, that accepts an optimization problem that can be formulated as BQP represented by
Maximize z^{T}Az+b^{T}z (Expression A)
by use of an n×n square matrix A and an n-dimensional vector b;
a condition storage unit that stores characteristic conditions representing characteristics of a positive weighted directed graph; and
an optimization unit, implemented by the processor, that solves the accepted optimization problem,
wherein the accepting unit accepts an optimization problem in which the BQP in Expression A satisfies constraints represented by Expression B
subject to z=[z₁, . . . ,zₙ]^{T}∈{0,1}ⁿ
zᵢ≤zⱼ ((i,j)∈C), (Expression B)
in a case where C is defined as an N×N combination, and
the optimization unit transforms the optimization problem based on the characteristic conditions, and solves the accepted optimization problem by solving the transformed problem as a minimum cut problem of a network flow.

2. The optimization system according to claim 1, wherein
the condition storage unit stores characteristic conditions represented by Expression D
$$V = \{ s , t \} ⊔ N , \\ E = \{ ( i , j ) ∈ N \times N \vert {a}_{ij} \neq 0 \} ⋃ \{ ( i , t ) ∈ N \times \{ t ] \vert i ∈ {M}_{1} \} ⋃ \{ ( s , i ) ∈ \{ s \} \times N \vert i ∈ {M}_{2} \} ⋃ C \\ w ( i , j ) = \{ \begin{matrix}{a}_{ij} & ( i , j ∈ N , {a}_{ij} \neq 0 ) \\ {p}_{i} & ( i ∈ {M}_{1} , j = t ) \\ {q}_{j} & ( i = s , j ∈ {M}_{2} ) \\ L & ( ( i , j ) ∈ C )\end{matrix} \qquad ( Expression D )$$
in a case where Expression C
$${M}_{1} = \{ i ∈ N \text{:} {b}_{i} + {\sum }_{j ∈ N \backslash \{ i \}} {a}_{ij} < 0 \} , \\ {M}_{2} = \{ i ∈ N \text{:} {b}_{i} + {\sum }_{j ∈ N \backslash \{ i \}} {a}_{ij} > 0 \} , \\ {p}_{i} = - ( {b}_{i} + {\sum }_{j ∈ N \backslash \{ i \}} {a}_{ij} ) ( i ∈ {M}_{1} ) \\ {q}_{i} = {b}_{i} + {\sum }_{j ∈ N \backslash \{ i \}} {a}_{ij} ( i ∈ {M}_{2} ) \qquad ( Expression C )$$
is defined such that aᵢⱼ is an element of A, and bᵢ is an element of b.

3. The optimization system according to claim 1, wherein
the accepting unit accepts an optimization problem for optimizing prices of a plurality of products so as to maximize total sales, and one or more candidate prices as constraints, and
the optimization unit solves the optimization problem under the accepted constraints.

4. The optimization system according to claim 1, wherein
the optimization unit solves the accepted optimization problem under a constraint where all elements of the square matrix A are non-negative.

5. An optimization method comprising:
accepting an optimization problem in which BQP in Expression A
Maximize z^{T}Az+b^{T}z (Expression A)
satisfies constraints represented by Expression B
subject to z=[z₁, . . . ,zₙ]^{T}{0,1}ⁿ
zᵢ≤zⱼ ((i,j)∈C), (Expression B)
in a case where C is defined as an N×N combination, among optimization problems that can be formulated as the BQP represented by Expression A by use of an n×n square matrix A and an n-dimensional vector b; and
transforming the optimization problem based on characteristic conditions representing characteristics of a positive weighted directed graph, and solving the accepted optimization problem by solving the transformed problem as a minimum cut problem of a network flow.

6. The optimization method according to claim 5, further comprising
transforming the optimization problem based on characteristic conditions represented by Expression D
$$V = \{ s , t \} ⊔ N , \\ E = \{ ( i , j ) ∈ N \times N \vert {a}_{ij} \neq 0 \} ⋃ \{ ( i , t ) ∈ N \times \{ t ] \vert i ∈ {M}_{1} \} ⋃ \{ ( s , i ) ∈ \{ s \} \times N \vert i ∈ {M}_{2} \} ⋃ C \\ w ( i , j ) = \{ \begin{matrix}{a}_{ij} & ( i , j ∈ N , {a}_{ij} \neq 0 ) \\ {p}_{i} & ( i ∈ {M}_{1} , j = t ) \\ {q}_{j} & ( i = s , j ∈ {M}_{2} ) \\ L & ( ( i , j ) ∈ C )\end{matrix} \qquad ( Expression D )$$
in a case where Expression C
$${M}_{1} = \{ i ∈ N \text{:} {b}_{i} + {\sum }_{j ∈ N \backslash \{ i \}} {a}_{ij} < 0 \} , \\ {M}_{2} = \{ i ∈ N \text{:} {b}_{i} + {\sum }_{j ∈ N \backslash \{ i \}} {a}_{ij} > 0 \} , \\ {p}_{i} = - ( {b}_{i} + {\sum }_{j ∈ N \backslash \{ i \}} {a}_{ij} ) ( i ∈ {M}_{1} ) \\ {q}_{i} = {b}_{i} + {\sum }_{j ∈ N \backslash \{ i \}} {a}_{ij} ( i ∈ {M}_{2} ) \qquad ( Expression C )$$
is defined such that aᵢⱼ is an element of A, and bᵢ is an element of b.

7. A non-transitory computer readable information recording medium storing an optimization program, when executed by a processor, that performs a method for:
accepting an optimization problem in which BQP in Expression A
Maximize z^{T}Az+b^{T}z (Expression A)
satisfies constraints represented by Expression B
subject to z=[z₁, . . . ,zₙ]^{T}∈{0,1}ⁿ
zᵢ≤zⱼ ((i,j)∈C), (Expression B)
in a case where C is defined as an N×N combination, among optimization problems that can be formulated as the BQP represented by Expression A by use of an n×n square matrix A and an n-dimensional vector b; and
transforming the optimization problem based on characteristic conditions representing characteristics of a positive weighted directed graph, and solving the accepted optimization problem by solving the transformed problem as a minimum cut problem of a network flow.

8. The non-transitory computer readable information recording medium according to claim 7, further comprising transforming the optimization problem based on characteristic conditions represented by Expression D
$$V = \{ s , t \} ⊔ N , \\ E = \{ ( i , j ) ∈ N \times N \vert {a}_{ij} \neq 0 \} ⋃ \{ ( i , t ) ∈ N \times \{ t ] \vert i ∈ {M}_{1} \} ⋃ \{ ( s , i ) ∈ \{ s \} \times N \vert i ∈ {M}_{2} \} ⋃ C \\ w ( i , j ) = \{ \begin{matrix}{a}_{ij} & ( i , j ∈ N , {a}_{ij} \neq 0 ) \\ {p}_{i} & ( i ∈ {M}_{1} , j = t ) \\ {q}_{j} & ( i = s , j ∈ {M}_{2} ) \\ L & ( ( i , j ) ∈ C )\end{matrix} \qquad ( Expression D )$$
in a case where Expression C
$${M}_{1} = \{ i ∈ N \text{:} {b}_{i} + {\sum }_{j ∈ N \backslash \{ i \}} {a}_{ij} < 0 \} , \\ {M}_{2} = \{ i ∈ N \text{:} {b}_{i} + {\sum }_{j ∈ N \backslash \{ i \}} {a}_{ij} > 0 \} , \\ {p}_{i} = - ( {b}_{i} + {\sum }_{j ∈ N \backslash \{ i \}} {a}_{ij} ) ( i ∈ {M}_{1} ) \\ {q}_{i} = {b}_{i} + {\sum }_{j ∈ N \backslash \{ i \}} {a}_{ij} ( i ∈ {M}_{2} ) \qquad ( Expression C )$$
is defined such that aᵢⱼ is an element of A, and bᵢ is an element of b.
